(19) United States
(12) Patent Application Publication
(10) Pub. No.: US 2023/0266881 A1
(43) Pub. Date: Aug. 24, 2023

(54) Low-Latency Scrambling for DDR DRAM

(71) Applicant: NUVOTON TECHNOLOGY CORPORATION, Hsin-chu (TW)

(72) Inventors: Joram Peer, Tel-Mond (IL); Uri Trichter, Herzliya (IL); Oved Oz, Raanana (IL); Avraham Fishman, Raanana (IL)

(21) Appl. No.: 18/092,356

(22) Filed: Jan. 2, 2023

(30) Foreign Application Priority Data
Feb. 20, 2022 (IL) 290753

(51) Int. Cl. G06F 3/06

(52) U.S. Cl. CPC G06F 3/0611; G06F 3/0659; G06F 3/0673

(57) ABSTRACT

An apparatus includes a memory controller and scrambling circuitry. The memory controller is configured to control a Dynamic Random-Access Memory (DRAM). The scrambling circuitry is configured to maintain one or more scrambling keys associated with one or more active rows of the DRAM, respectively, to identify a memory-access command, which is transferred between the memory controller and the DRAM and which addresses a given active row of the DRAM, and to apply to the command a scrambling key that is associated with the given active row.

### CROSS-REFERENCE TO RELATED APPLICATIONS

This application claims priority from Israel Patent Application 290,753, filed Feb. 20, 2022, whose disclosure is incorporated herein by reference.

### FIELD OF THE INVENTION

The present invention relates generally to memory systems, and particularly to methods and systems for scrambling data written and read from Dynamic Random-Access Memory (DRAM).

### BACKGROUND OF THE INVENTION

Various techniques for data encryption in memory systems are known in the art. Example techniques are described in the IEEE 1619 family of standards, which specify a standard architecture for encrypted shared storage media.

### SUMMARY OF THE INVENTION

An embodiment of the present invention that is described herein provides an apparatus including a memory controller and scrambling circuitry. The memory controller is configured to control a Dynamic Random-Access Memory (DRAM). The scrambling circuitry is configured to maintain one or more scrambling keys associated with one or more active rows of the DRAM, respectively, to identify a memory-access command, which is transferred between the memory controller and the DRAM and which addresses a given active row of the DRAM, and to apply to the command a scrambling key that is associated with the given active row.

In an embodiment, the scrambling circuitry is configured to detect an activation command, which is sent from the memory controller to the DRAM and instructs the DRAM to activate a specified row, and, in response to detecting the activation command, to generate a scrambling key for the specified row. In an example embodiment, the scrambling circuitry is configured to generate the scrambling key for the given active row based on (i) a row address of the given active row, and (ii) a random key. In a disclosed embodiment, in applying the scrambling key, the scrambling circuitry is configured to incur a latency of less than a single cycle.

There is additionally provided, in accordance with an embodiment that is described herein, a method in a memory controller that controls a Dynamic Random-Access Memory (DRAM). The method includes maintaining one or more scrambling keys associated with one or more active rows of the DRAM, respectively. A memory-access command, which is transferred between the memory controller and the DRAM and which addresses a given active row of the DRAM, is identified. A scrambling key, which is associated with the given active row, is applied to the command.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a memory system, in accordance with an embodiment of the present invention; and

FIG. 2 is a flow chart that schematically illustrates a method for scrambling in the memory system of FIG. 1, in accordance with an embodiment of the present invention.

### DETAILED DESCRIPTION OF EMBODIMENTS

### Overview

Known encryption techniques, such as those specified in the IEEE 1619 standards, are effective but incur high latency. Since DRAM access time has significant implication on system performance, these techniques may be useful in Hard Disk Drives (HDDs) or Flash-based Solid-State Drives (SSDs), but are not applicable to DRAM.

Embodiments of the present invention that are described herein provide methods and apparatus for scrambling information that is transferred between a memory controller and a DRAM, with very small latency. As will be described below, the disclosed techniques incur a latency of less than a single cycle.

In some embodiments described herein, a secure DRAM controller comprises a memory controller and scrambling circuitry. The scrambling circuitry may be inserted in the interface between the memory controller and a DDR PHY that in turn communicates with the DRAM. Alternatively, the scrambling circuitry may be integrated in the memory controller itself.

At any given time, the scrambling circuitry maintains respective scrambling keys for the rows of the DRAM that are currently “open” (i.e., active). The scrambling circuitry generates a new scrambling key in response to identifying an “activate” command, which instructs the DRAM to activate a specified row. At a later time, in response to identifying a read or write command that addresses an open row, the scrambling circuitry applies the scrambling key of that row to the data and/or address of the command. In the present context, the phrase “applying a scrambling key to a command” refers to scrambling the entire command or any suitable part of the command, e.g., some or all of the command opcode, some or all of the command address, and/or some or all of the command data.

Example implementations for the secure DRAM controller, and in particular for the scrambling circuitry, are described herein. The disclosed scrambling scheme achieves a high level of security against various security attacks, e.g., “Cold Boot” attacks. At the same time, the disclosed techniques incur only minimal latency. Moreover, the disclosed techniques do not require any cooperation or awareness from the memory controller or DRAM.

### System Description

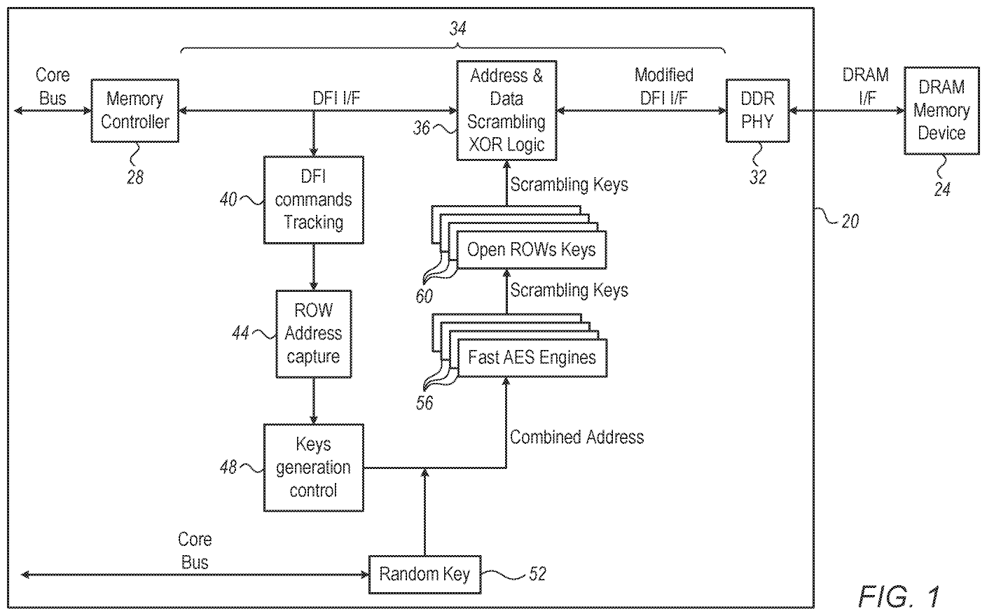

FIG. 1 is a block diagram that schematically illustrates a memory system, in accordance with an embodiment of the present invention. The memory system comprises a secure DRAM controller 20 that stores data in one or more DRAM devices 24. The present example refers to a single DDR4 DRAM device. Alternatively, any other suitable type of DRAM or DRAMs can be used. Secure DRAM controller 20 communicates with a host (not seen in the figure) over one or more core buses.

Secure DRAM controller 20 comprises a memory controller 28, which sends commands to DRAM 24 via a DDR PHY 32. The commands may comprise, for example, “activate” commands that activate selected rows of the DRAM, read and write commands that read and write data in previously activated rows, or any other suitable commands. In the present example, the commands and the command interface between memory controller 28 and DDR PHY 32 are in accordance with “DFI-DDR PHY Interface,” DFI 3.1 Specification, Mar. 21, 2014.

In order to obfuscate the information (data and/or addresses) transferred over the DRAM interface between DDR PHY 32 and DRAM 24, secure DRAM controller 20 further comprises scrambling circuitry 34 that is inserted in the DFI interface between memory controller 28 and DDR PHY 32.

In principle, scrambling circuitry 34 generates and maintains a respective scrambling key for each row of DRAM 24 that is currently “open” (i.e., active). The scrambling circuitry generates a new scrambling key in response to identifying an “activate” command on the DFI interface, which instructs DRAM 24 to activate a specified row. At a later time, in response to identifying a read or write command that addresses an open row, scrambling circuitry 34 uses the scrambling key 60 of that row to scramble (in the case of write) or descramble (in the case of read) the command data and/or address.

In some embodiments, scrambling circuitry 34 of secure DRAM controller 20 comprises the following modules:
Scrambling and XOR logic 36.
A DFI commands tracking module 40.
A row address capturing module 44.
A keys generation control module 48.
One or more fast Advanced Encryption Standard (AES) engines 56.
An internal memory (not seen explicitly in the figure) for storing a random key 52 and a plurality of scrambling keys 60.

Typically, secure DRAM controller 20 receives a random key 52 from the host over the core bus, e.g., upon initialization.

In various embodiments, the storage elements that store scrambling keys 60 can be implemented in various ways, e.g., as registers (flops) or as a memory array such as a Static RAM (SRAM) Array or Dual Port RAM (DPRAM) Array. Implementation may differ according to the process technology used and the size of the keys used. In the case of SRAM or DPRAM implementation, a clock may be needed to clock access to the array. Access to the data structure storing scrambling keys 60, whether implemented as registers (flops), SRAM or DPRAM, may be permitted to take a cycle or more, limited by DFI programmable timing parameters tWRLAT (Write Latency) plus tWRDATA_EN for Write commands and tRDLAT plus tRDDATA_EN for Read commands.

During normal, ongoing operation of the system, DFI commands tracking module 40 monitors the DFI commands on the DFI interface. When module 40 detects an “activate” command, row address capturing module 44 captures the row address (RA) specified in the command. Keys generation control module 48 combines the row address with random key 52, to generate a combined address. AES engines 56 derive a scrambling key 60 from the combined address. In an example embodiment, all AES engines 56 operate in parallel to jointly generate scrambling key 60, e.g., with each AES engine 56 generating a subset of the bits of the scrambling key. This scrambling key is associated uniquely with the row that was specified in the “activate” command—A row that is known to be open. In this manner, secure DRAM controller maintains a set of scrambling keys 60, each scrambling key corresponding to a respective row that is currently open.

DFI commands tracking module 40 continues to monitor the DFI commands on the DFI interface. When detecting a memory-access command (read or write), scrambling and XOR logic 36 uses the bank address specified in the command to select the scrambling key 60 associated with the open row to which the command is addressed. Logic 36 uses the column address (CA) in the command for finer granularity of specific bits within the selected scrambling key 60.

Logic 36 scrambles a specified part of the command according to the selected scrambling key 60. Scrambling may comprise one or more bit-wise XOR operations between specified bits of the key and specified bits of the command, and/or one or more bit-position swap operations controlled by specified bits of the scrambling key. The specified part of the command may comprise any suitable part of the command (including op-code, address and/or data), or even the entire command. In an example embodiment, the part undergoing bit-wise XOR comprises the CA and at least part of the data. In addition to bit-wise XOR, logic 36 may also perform other scrambling operations such as swapping of bit positions among the bits of the data and CA.

For a write command (from memory controller 28 to DDR PHY 32) the bit-wise XOR operation scrambles the command. For a read command (from DDR PHY 32 to memory controller 28) the bit-wise XOR operation descrambles the command. In both cases, the added latency is typically less than a single cycle of the DFI interface. For a read operation, the descrambling of the data is delayed by a programmable number of cycles (CAS latency), to the time the read data is available. At the cycle at which the data is available, the descrambling is done within a single cycle.

The configuration of the memory system of FIG. 1, including secure DRAM controller 20 and its components, is an example configuration that is shown purely for the sake of conceptual clarity. Any other suitable configuration can be used in alternative embodiments. The various components of secure DRAM controller 20 may be implemented using suitable hardware, such as in one or more Application-Specific Integrated Circuits (ASICs) or Field-Programmable Gate Arrays (FPGAs), using software, or using a combination of hardware and software elements.

Although the embodiments described herein mainly address scrambling of information transferred between a memory controller and a DRAM, the methods and systems described herein can also be used in other applications, such as with other types of memory, e.g., Non-Volatile RAM (NVRAM), Ferroelectric RAM, Magneto-resistive RAM (MRAM), Phase-Change RAM (PRAM), and the like.

### Scrambling Method Description

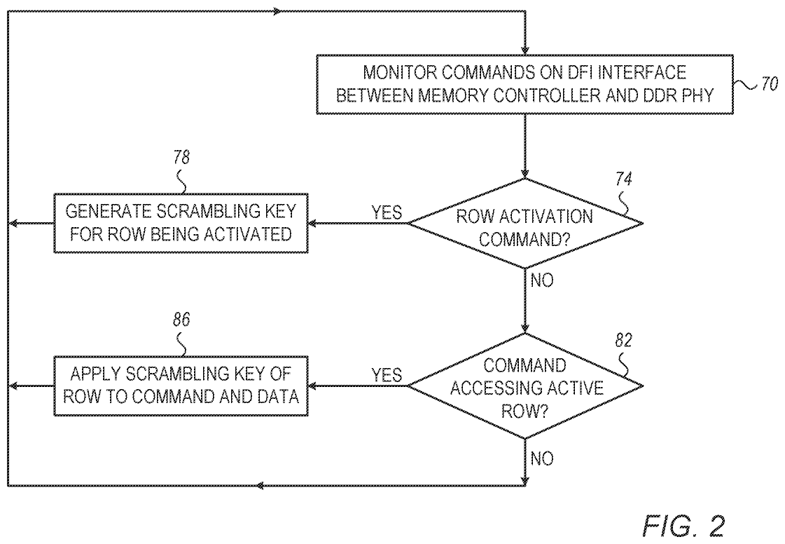

FIG. 2 is a flow chart that schematically illustrates a method for scrambling in the memory system of FIG. 1, in accordance with an embodiment of the present invention. The method begins with DFI commands tracking module 40 monitoring the DFI commands on the DFI interface, at a monitoring stage 70.

At an activation checking stage 74, module 40 checks for the presence of an “activate” command on the DFI interface. If an “activate” command is detected, keys generation control module 48 and AES engines 56 generate a scrambling key 60 for the row in question, at a key generation stage 78. As explained above, keys generation control module 48 combines the row address (RA) of the command with random key 52, to generate a combined address, and instructs AES engines 56 to derive a scrambling key 60 from the combined address. The method then loops back to stage 70, in which module 40 continues to monitor the DFI interface.

Otherwise, at an access checking stage 82, module 40 checks for the presence of a memory access command (read or write) that accesses an active row. If a memory access command is detected, scrambling and XOR logic 36 applies the appropriate scrambling key 60 to the command and data, at a scrambling stage 86. As explained above, logic 36 selects the scrambling key 60 associated with the open row to which the command is addressed, and then scrambles a specified part of the command according to the selected scrambling key. If no memory access command is detected, stage 86 is skipped. The method loops back to stage 70.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An apparatus, comprising:
a memory controller, configured to control a Dynamic Random-Access Memory (DRAM); and
scrambling circuitry, configured to:
maintain one or more scrambling keys associated with one or more active rows of the DRAM, respectively;
identify a memory-access command, which is transferred between the memory controller and the DRAM and which addresses a given active row of the DRAM; and
apply to the command a scrambling key that is associated with the given active row.

2. The apparatus according to claim 1, wherein the scrambling circuitry is configured to detect an activation command, which is sent from the memory controller to the DRAM and instructs the DRAM to activate a specified row, and, in response to detecting the activation command, to generate a scrambling key for the specified row.

3. The apparatus according to claim 1, wherein the scrambling circuitry is configured to generate the scrambling key for the given active row based on (i) a row address of the given active row, and (ii) a random key.

4. The apparatus according to claim 1, wherein, in applying the scrambling key, the scrambling circuitry is configured to incur a latency of less than a single cycle.

5. A method in a memory controller that controls a Dynamic Random-Access Memory (DRAM), the method comprising:
maintaining one or more scrambling keys associated with one or more active rows of the DRAM, respectively;
identifying a memory-access command, which is transferred between the memory controller and the DRAM and which addresses a given active row of the DRAM; and
applying to the command a scrambling key that is associated with the given active row.

6. The method according to claim 5, wherein maintaining the scrambling keys comprises detecting an activation command, which is sent from the memory controller to the DRAM and instructs the DRAM to activate a specified row, and, in response to detecting the activation command, generating a scrambling key for the specified row.

7. The method according to claim 5, wherein maintaining the scrambling keys comprises generating the scrambling key for the given active row based on (i) a row address of the given active row, and (ii) a random key.

8. The method according to claim 5, wherein applying the scrambling key is performed while incurring a latency of less than a single cycle.
